(19) United States
(12) Patent Application Publication
(10) Pub. No.: US 2020/0149674 A1
(43) Pub. Date: May 14, 2020

(54) METHOD FOR COATING A PIPELINE FIELD JOINT

(71) Applicant: Dow Global Technologies LLC, Midland, MI (US)

(72) Inventors: Rujul M. Mehta, Manvel, TX (US); Mark W. Brown, II, Richwood, TX (US); Amanda M. Goodman, Missouri City, TX (US); Bhawesh Kumar, Lake Jackson, TX (US); Qichun Wan, Midland, MI (US)

(21) Appl. No.: 16/613,361

(22) PCT Filed: Apr. 17, 2018
(86) PCT No.: PCT/US2018/027850

§ 371 Date: Nov. 13, 2019

Related U.S. Application Data
(60) Provisional application No. 62/512,756, filed on May 31, 2017.

(51) Int. Cl. F16L 58/18; B29C 63/00; C09D 5/00; C09D 123/16; C09D 123/26; C09D 153/00; C09D 123/12; C09D 175/08; C09D 163/00; C09D 183/10

(52) U.S. Cl. CPC F16L 58/18; B29C 63/0073; C09D 5/002; C09D 123/16; C09D 123/26; B29L 2023/22; C09D 123/12; C09D 175/08; C09D 163/00; C09D 183/10; C09D 153/00

(57) ABSTRACT

The present invention relates to a method of coating a pipeline field joint comprising the steps of (1) applying a layer of a first coating material comprising a substantially linear ethylene polymer, a linear ethylene polymer, or an olefin block copolymer to the uncoated region of the field joint and (2) subsequently applying a layer of a second coating material comprising a polyurethane, an epoxy, or a cross linked polyethylene to the field joint.

### FIELD OF THE INVENTION

The present invention relates to improvements in coating pipes, and in particular to a method for coating pipeline field joints and a coated pipeline field joint.

### BACKGROUND OF THE INVENTION

Pipelines used in the oil and gas industry are usually formed of lengths of steel pipe welded together end-to-end as the pipeline is laid. It is also common to fabricate a pipe stalk onshore at a spoolbase and to transport the prefabricated pipe offshore for laying, for example in a reel-lay operation in which pipe stalks are welded together and stored in a compact spooled form on a pipelay vessel.

To mitigate corrosion of the pipeline and optionally also to insulate the fluids that the pipeline carries in use, the pipe joints are pre-coated with protective coatings that, optionally, are also thermally insulating. Many variations are possible in the structure and composition of the coating to obtain the required protective or insulative properties. However, polypropylene (PP) is most commonly used to coat the pipe joints from which pipelines are made. For example, a so-called three-layer PP (3LPP) coating may be used for corrosion protection and a so-called five-layer PP (5LPP) coating may be used for additional thermal insulation. Additional layers are possible.

A 3LPP coating typically comprises an epoxy primer applied to the cleaned outer surface of the steel pipe joint. As the primer cures, a second thin layer of PP is applied so as to bond with the primer and then a third, thicker layer of extruded PP is applied over the second layer for mechanical protection. A 5LPP coating adds two further layers, namely a fourth layer of PP modified for thermal insulation e.g. glass syntactic PP (GSPP) or a foam, surrounded by a fifth layer of extruded PP for mechanical protection of the insulating fourth layer.

A short length of pipe is left uncoated at each end of the pipe joint to facilitate welding. The resulting ‘field joint’ must be coated with a field joint coating to mitigate corrosion and to maintain whatever level of insulation may be necessary for the purposes of the pipeline.

Two common processes for coating field joints of pipelines formed from polypropylene coated pipes are the Injection Molded Polypropylene (IMPP) and Injection Molded Polyurethane (IMPU) techniques.

An IMPP coating is typically applied by first blast cleaning and then heating the pipe using induction heating, for instance. A layer of powdered fusion bonded epoxy (FBE) primer is then applied to the heated pipe, together with a thin adhesive layer of polypropylene, which is added during the curing time of the FBE. Exposed chamfers of factory applied coating on the pipe are then heated. The field joint is then completely enclosed by a heavy duty, high pressure mold that defines a cavity around the uncoated ends of the pipes, which is subsequently filled with molten polypropylene. Once the polypropylene has cooled and solidified, the mold is removed leaving the field joint coating in place.

Because the polypropylene used for re-insulation has broadly similar mechanical and thermal properties to the pipe coating of PP, the pipe coating and the field joint coating are sufficiently compatible that they fuse together at their mutual interface.

By contrast, an IMPU coating uses a chemically curable material instead of injecting polypropylene as the infill material in the IMPP field joint. Typically, the initial step in the IMPU technique is to apply a liquid polyurethane primer onto the exposed blast cleaned surface of the pipe. Once the primer has been applied, a mold is positioned to enclose the field joint in a cavity and the chemically curable material is injected into the cavity defined by the mold. The infill material is typically a two component urethane chemical. When the curing process is sufficiently advanced, the mold can be removed and the field joint coating can be left in place.

An IMPU process is advantageous because this process depends on a curing time versus a cooling time which can result in a shorter coating cycle. Further, the mold used in an IMPU operation does not need to withstand high pressures and so can be of compact, lightweight and simple design.

However, existing insulated pipelines comprising field joints with one of the above mentioned insulating materials, while demonstrating a number of significant advantages, can still have certain limitations, for example cracking. For instance, with PU coatings, shrinkage caused during curing may cause internal stresses that can lead to cracks in the insulation. Cracking may also occur when the insulation material and underlying steel equipment are heated and cooled. During heating the inner surface of the insulation material (adjacent the hot steel equipment) expands more than the outer surface of the insulation material (adjacent the cold sea water). This differential expansion may also cause cracking. During cooling, the insulation material shrinks more and faster than the steel equipment, causing more cracking.

New insulation materials which reduce internal stresses and cracking in the molded insulation have been disclosed, for example see US Publication No. 2015/0074978; WO 2017/019679; and copending U.S. provisional application No. 62/381,037. However, due to the chemically dissimilar nature of the new field joint coatings and the PP pipe coatings, the maximum bond strength that can be achieved between them and the polypropylene with conventional adhesive layers and/or primers is lower than the maximum bond strength that can be achieved between polypropylene/polypropylene or polyurethane/polypropylene. Because of this, there is a perceived risk that fractures may occur between the pipe and new non-PP field joint coatings, which is undesirable as it may allow water to penetrate the pipe coating causing corrosion of the pipe.

There exists a need for an improved adhesive layer material and coating process to adequately bond conventional PP pipe coatings with non-PP field joint coatings.

### SUMMARY OF THE INVENTION

The present invention is a method of coating a pipeline field joint between two joined lengths of pipe, each length comprising a polypropylene pipe coating along part of its length and an uncoated end portion between where the polypropylene pipe coating ends and the field joint, the method comprising the steps of (i) applying a layer of a first coating material comprising a substantially linear ethylene polymer (SLEP), a linear ethylene polymer (LEP), or an olefin block copolymer (OBC) to the uncoated region of the field joint such that it overlaps with and extends continuously between the polypropylene pipe coating of each of the two lengths of pipe and (ii) subsequently applying a layer of a second coating material comprising a polyurethane, an epoxy, or a cross linked polyethylene to the field joint, wherein the second coating material contacts and completely covers the layer of the first coating material.

In one embodiment of the method disclosed herein above, the substantially linear ethylene polymer and/or linear ethylene polymer is characterized as having (a) a density of less than about 0.873 g/cc to 0.885 g/cc and/or (b) an I₂ of from greater than 1 g/10 min to less than 5 g/10 min.

In one embodiment of the method disclosed herein above, the OBC comprises one or more hard segment and one or more soft segment having an MFR equal to or greater than 5 g/10 min (at 190° C. under an applied load of 2.16 kg), more preferably wherein the OBC is characterized by one or more of the aspects described as follows:
(i.a) has a weight average molecular weight/number average molecular weight ratio (Mw/Mn) from about 1.7 to about 3.5, at least one melting peak (Tm) in degrees Celsius, and a density (d) in grams/cubic centimeter (g/cc), wherein the numerical values of Tm and d correspond to the relationship:
Tₘ>−2002.9+4538.5(d)−2422.2(d)² or Tₘ>−6553.3+13735(d)−7051.7(d)²; or
(i.b) has a Mw/Mn from about 1.7 to about 3.5, and is characterized by a heat of fusion (ΔH) J/g and a delta quantity, ΔT, in degrees Celsius defined as the temperature difference between the tallest differential scanning calorimetry (DSC) peak and the tallest crystallization analysis fractionation (CRYSTAF) peak, wherein the numerical values of ΔT and ΔH have the following relationships:
ΔT>−0.1299(ΔH)+62.81 for ΔH greater than zero and up to 130 J/g,
ΔT≥48° C. for ΔH greater than 130 J/g,
wherein the CRYSTAF peak is determined using at least 5 percent of the cumulative polymer, and if less than 5 percent of the polymer has an identifiable CRYSTAF peak, then the CRYSTAF temperature is 30° C.; or
(i.c) is characterized by an elastic recovery (Re) in percent at 300 percent strain and 1 cycle measured with a compression-molded film of the ethylene/alpha-olefin interpolymer, and has a density (d) in grams/cubic centimeter (g/cc), wherein the numerical values of Re and d satisfy the following relationship when ethylene/alpha-olefin interpolymer is substantially free of a cross-linked phase: Re>1481-1629(d); or
(i.d) has a molecular fraction which elutes between 40° C. and 130° C. when fractionated using TREF, characterized in that the fraction has a molar comonomer content greater than, or equal to, the quantity (−0.2013) T+20.07, more preferably greater than or equal to the quantity (−0.2013) T+21.07, where T is the numerical value of the peak elution temperature of the TREF fraction, measured in ° C.; or
(i.e) has a storage modulus at 25° C. (G′(25° C.)) and a storage modulus at 100° C. (G′(100° C.)) wherein the ratio of G′(25° C.) to G′(100° C.) is in the range of about 1:1 to about 9:1 or
(i.f) has a molecular fraction which elutes between 40° C. and 130° C. when fractionated using TREF, characterized in that the fraction has a block index of at least 0.5 and up to about 1 and a molecular weight distribution, Mw/Mn, greater than about 1.3; or
(i.g) has an average block index greater than zero and up to about 1.0 and a molecular weight distribution, Mw/Mn, greater than about 1.3.

In one embodiment of the method disclosed herein above, the second coating material is formed from a composition comprising (a) a mixture of polyurethane based chemicals that cures to form a polyurethane elastomer, (b) an epoxy composition, or (c) a cross-linkable polyolefin mixture.

In one embodiment of the method disclosed herein above, the second coating material is a polyurethane elastomer which is a reaction product of a reaction mixture comprising at least one polyether polyol having a hydroxyl equivalent weight of at least 1000, 1 to 20 parts by weight of 1,4-butanediol per 100 parts by weight of the polyether polyol(s), an aromatic polyisocyanate in amount to provide an isocyanate index of 80 to 130 and a zinc carboxylate catalyst.

In one embodiment of the method disclosed herein above, the second coating material is an epoxy composition which is a reaction product of (a) an ambient temperature liquid epoxy-terminated prepolymer formed by reacting a polyoxyalkyleneamine having a molecular weight of from 3,000 to 20,000 with an excess of epoxide, wherein the polyoxyalkyleneamine has at least 3 active hydrogen atoms and (b) a curing agent comprising at least one amine or polyamine having an equivalent weight of less than 200 and having 2 to 5 active hydrogen atoms.

In one embodiment of the method disclosed herein above, the second coating material comprises a cross-linkable mixture comprising: (i) one or more ethylene polymer, (ii) one or more silane, (iii) one or more polyfunctional organopolysiloxane with a functional end group, (iv) one or more cross-linking catalyst, and (v) optionally one or more filler and/or additive, more preferably, (i) the ethylene polymer is a very low density polyethylene, a linear low density polyethylene, a homogeneously branched polyethylene, a linear ethylene/alpha-olefin copolymer, a homogeneously branched substantially linear ethylene/alpha-olefin polymer, or an ethylene block copolymer, (ii) the silane has the formula:

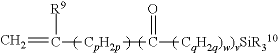

wherein R⁹ is a hydrogen atom or methyl group;

v and w are 0 or 1 with the proviso that when v is 1, w is 1;

p is an integer from 0 to 12 inclusive,

q is an integer from 1 to 12 inclusive, and

each R¹⁰ independently is a hydrolyzable organic group,

(iii) the polyfunctional organopolysiloxane (iii) is a polydimethylsiloxane of the formula:

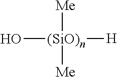

wherein Me is methyl and n is from 10 to 400, and

(iv) the cross-linking catalyst is a Lewis or Bronsted acid or base.

### DETAILED DESCRIPTION OF THE INVENTION

One embodiment of the present invention is a method of coating a pipeline field joint between two joined lengths of pipe, each length being coated along part of its length, but not on the ends being joined, with a pipe coating, any suitable factory coating, but preferably a 3LPP or a 5LPP coating. Subsequent to welding the pipes together, the method comprises the steps of: i) applying a first layer of a first coating material to the uncoated region of the field joint (i.e., the uncoated ends of the pipes) such that it contacts and extends between the pipe coating of each of the two lengths of pipe and ii) subsequently applying a second layer of a second coating material to the field joint, such that the second coating material is in contact with the first coating material.

In the embodiment where the first coating material is in the form of a liquid, application of the first coating material may include brushing or spraying onto the field joint.

In another embodiment, the first coating material is in the form of a tape and application may include the step of wrapping the tape around the field joint, preferably in a helical pattern although other patterns may be used. Heat may be applied to the tape before and/or during and/or after wrapping the tape around the field joint. Heating the tape and/or field joint may promote the wrapped layers of the tape to fuse together more efficiently, thereby creating a more secure protective layer around the field joint.

In another embodiment, the first coating material may be applied in powdered form or by flame spraying in order to build up the first layer.

Alternatively, in another embodiment, a continuous sleeve of the first coating material may be positioned around the field joint and fastened to the coating materials by conventional techniques, which in one embodiment involves a plastic welding process. In another embodiment, the first coating material may instead be in the form of a heat-shrinkable sleeve that is heat-shrunk to coat the area of the field joint.

Of course, it is to be appreciated that any suitable technique of applying the first coating material may be used in accordance with the present invention, for example brushing on, spraying on, or, if the first coating material is in the form of a tape, wrapping it around the pipe joint and exposed pipe.

In the method of the invention, however the first coating material is applied, it is applied to overlap or cover at least some of the pipe coating on the uncovered end(s) of the joined pipes, to allow the coating materials to contact and form a resistant barrier to moisture and other contaminants. Where the first coating material is in the form of a tape, the tape is wrapped around the field joint such that it overlaps and covers at least part or all of the pipe coating on the uncovered end(s) of the pipe.

Subsequently, a layer of a second material is applied over the first layer of first material to provide additional mechanical strength and thermal insulation to the field joint. Application of the second coating material may include fitting a split injection mold around the connected region of the field joint and injecting the second material into the mold by conventional high pressure (i.e., IMPP) or low pressure (i.e., IMPU) injection molding techniques.

In one embodiment, the second layer may comprise a single polymeric material which may be injection molded into a high pressure mold fitted around the field joint.

In another embodiment, the second coating material may be formed by combining two or more components, for example, polyurethane chemicals that combine, react, and cure to form a polyurethane. Components may be combined prior to injection into the mold, or during injection into the mold, or in the mold itself. In a two component system, the injected mixture may retain the relatively low viscosity of the components which thereby reduces the pressure during injection and allows lightweight molds to be used compared to the heavy duty, high pressure molds associated with IMP coating techniques.

Typically, the layer of the first coating material has a thickness in the range of about 1.0 mm to about 5.0 mm and the layer of the second coating material independently has a thickness of at least 5.0 mm, or at least 20 mm. Preferably the layer of second coating material is of sufficient thickness to extend slightly beyond the factory coating. As such it could have a thickness of the order of 150 mm. However, it is to be appreciated that any relative thicknesses may be used depending upon the particular application and desired degree of thermal insulation. In one embodiment, the layer of the first coating material is of less thickness than the layer of the second coating material.

In one embodiment of the process of the present invention, the field joint is cleaned prior to the application of the first coating material. Cleaning methods include surface dust wiping off, surface sanding, surface dissolve cleaning, scraping, and the like. Any suitable cleaning solution and/or procedure used for cleaning such pipe can be used.

In one embodiment, the first coating used in the process of the present invention is a substantially linear ethylene polymer (SLEP) or a linear ethylene polymer (LEP), or mixtures thereof. As used herein, the term “S/LEP” refers to substantially linear ethylene polymers, linear ethylene polymers, or mixtures thereof. S/LEP polymers are made using a constrained geometry catalysts, such as a metallocene catalysts. S/LEP polymers are not made by conventional polyethylene copolymer processes, such as Ziegler Natta catalyst polymerization (HDPE) or free radical polymerization (LDPE and LLDPE).

Both substantially linear ethylene polymers and linear ethylene polymers are known. Substantially linear ethylene polymers and their method of preparation are fully described in U.S. Pat. Nos. 5,272,236 and 5,278,272. Linear ethylene polymers and their method of preparation are fully disclosed in U.S. Pat. Nos. 3,645,992; 4,937,299; 4,701,432; 4,937,301; 4,935,397; 5,055,438; EP 129,368; EP 260,999; and WO 90/07526.

Suitable S/LEP comprises one or more C₂ to C₂₀ alpha-olefins in polymerized form, having a T_{g} less than 25° C., preferably less than 0° C., most preferably less than −25° C. Examples of the types of polymers from which the present S/LEP are selected include copolymers of alpha-olefins, such as ethylene and 1-butene, ethylene and 1-hexene or ethylene and 1-octene copolymers, and terpolymers of ethylene, propylene and a diene comonomer such as hexadiene or ethylidene norbornene, most preferred is ethylene and propylene.

As used here, “a linear ethylene polymer” means a homopolymer of ethylene or a copolymer of ethylene and one or more alpha-olefin comonomers having a linear backbone (i.e. no cross linking), no long-chain branching, a narrow molecular weight distribution and, for alpha-olefin copolymers, a narrow composition distribution. Further, as used here, “a substantially linear ethylene polymer” means a homopolymer of ethylene or a copolymer of ethylene and of one or more alpha-olefin comonomers having a linear backbone, a specific and limited amount of long-chain branching, a narrow molecular weight distribution and, for alpha-olefin copolymers, a narrow composition distribution.

Short-chain branches in a linear copolymer arise from the pendent alkyl group resulting upon polymerization of intentionally added C₃ to C₂₀ alpha-olefin comonomers. Narrow composition distribution is also sometimes referred to as homogeneous short-chain branching. Narrow composition distribution and homogeneous short-chain branching refer to the fact that the alpha-olefin comonomer is randomly distributed within a given copolymer of ethylene and an alpha-olefin comonomer and virtually all of the copolymer molecules have the same ethylene to comonomer ratio. The narrowness of the composition distribution is indicated by the value of the Composition Distribution Branch Index (CDBI) or sometimes referred to as Short Chain Branch Distribution Index. CDBI is defined as the weight percent of the polymer molecules having a comonomer content within 50 percent of the median molar comonomer content. The CDBI is readily calculated, for example, by employing temperature rising elution fractionation, as described in Wild, Journal of Polymer Science, Polymer Physics Edition, Volume 20, page 441 (1982), or U.S. Pat. No. 4,798,081. The CDBI for the substantially linear ethylene copolymers and the linear ethylene copolymers in the present invention is greater than about 30 percent, preferably greater than about 50 percent, and more preferably greater than about 90 percent.

Long-chain branches in substantially linear ethylene polymers are polymer branches other than short chain branches. Typically, long chain branches are formed by in situ generation of an oligomeric alpha-olefin via beta-hydride elimination in a growing polymer chain. The resulting species is a relatively high molecular weight vinyl terminated hydrocarbon which upon polymerization yields a large pendent alkyl group. Long-chain branching may be further defined as hydrocarbon branches to a polymer backbone having a chain length greater than n minus 2 (“n−2”) carbons, where n is the number of carbons of the largest alpha-olefin comonomer intentionally added to the reactor. Preferred long-chain branches in homopolymers of ethylene or copolymers of ethylene and one or more C₃ to C₂₀ alpha-olefin comonomers have at least from 20 carbons up to more preferably the number of carbons in the polymer backbone from which the branch is pendant. Long-chain branching may be distinguished using ¹³C nuclear magnetic resonance spectroscopy alone, or with gel permeation chromatography-laser light scattering (GPC-LALS) or a similar analytical technique. Substantially linear ethylene polymers contain at least 0.01 long-chain branches/1000 carbons and preferably 0.05 long-chain branches/1000 carbons. In general, substantially linear ethylene polymers contain less than or equal to 3 long-chain branches/1000 carbons and preferably less than or equal to 1 long-chain branch/1000 carbons.

As used here, copolymer means a polymer of two or more intentionally added comonomers, for example, such as might be prepared by polymerizing ethylene with at least one other C₃ to C₂₀ comonomer. Preferred linear ethylene polymers may be prepared in a similar manner using, for instance, metallocene or vanadium based catalyst under conditions that do not permit polymerization of monomers other than those intentionally added to the reactor. Preferred substantially linear ethylene polymers are prepared by using metallocene based catalysts. Other basic characteristics of substantially linear ethylene polymers or linear ethylene polymers include a low residuals content (i.e. a low concentration therein of the catalyst used to prepare the polymer, unreacted comonomers and low molecular weight oligomers made during the course of the polymerization), and a controlled molecular architecture which provides good processability even though the molecular weight distribution is narrow relative to conventional olefin polymers.

While the substantially linear ethylene polymers or the linear ethylene polymers used in the practice of this invention include substantially linear ethylene homopolymers or linear ethylene homopolymers, preferably the substantially linear ethylene polymers or the linear ethylene polymers comprise between about 50 to about 95 weight percent ethylene and about 5 to about 50, and preferably about 10 to about 25 weight percent of at least one alpha-olefin comonomer. The comonomer content in the substantially linear ethylene polymers or the linear ethylene polymers is generally calculated based on the amount added to the reactor and as can be measured using infrared spectroscopy according to ASTM D-2238, Method B. Typically, the substantially linear ethylene polymers or the linear ethylene polymers are copolymers of ethylene and one or more C₃ to C₂₀ alpha-olefins, preferably copolymers of ethylene and one or more C₃ to C₁₀, alpha-olefin comonomers and more preferably copolymers of ethylene and one or more comonomers selected from the group consisting of propylene, 1-butene, 1-hexene, 4-methyl-1-pentane, and 1-octene. Most preferably the copolymers are ethylene and 1-octene copolymers.

The density of these substantially linear ethylene polymers or linear ethylene polymers is equal to or greater than about 0.850 grams per cubic centimeter (g/cm³), preferably equal to or greater than about 0.860 g/cm³, and more preferably equal to or greater than about 0.873 g/cm³. Generally, the density of these substantially linear ethylene polymers or linear ethylene polymers is less than or equal to about 0.93 g/cm³, preferably less than or equal to about 0.900 g/cm³, and more preferably equal to or less than about 0.885 g/cm³. The melt flow ratio for substantially linear ethylene polymers, measured as I₁₀/I₂, is greater than or equal to about 5.63, is preferably from about 6.5 to about 15, and is more preferably from about 7 to about 10. I₂ is measured according to ASTM Designation D 1238 using conditions of 190° C. and 2.16 kilogram (kg) mass. I₁₀ is measured according to ASTM Designation D 1238 using conditions of 190° C. and 10.0 kg mass.

The M_{w}/Mₙ for substantially linear ethylene polymers is the weight average molecular weight (M_{w}) divided by number average molecular weight (Mₙ). M_{w} and Mₙ are measured by gel permeation chromatography (GPC). For substantially linear ethylene polymers, the I₁₀/I₂ ratio indicates the degree of long-chain branching, i.e. the larger the I₁₀/I₂ ratio, the more long-chain branching exists in the polymer. In preferred substantially linear ethylene polymers M_{w}/Mₙ is related to I₁₀/I₂ by the equation: M_{w}/Mₙ≤(I₁₀/I₂)−4.63. Generally, M_{w}/Mₙ for substantially linear ethylene polymers is at least about 1.5 and preferably at least about 2.0 and is less than or equal to about 3.5, more preferably less than or equal to about 3.0. In a most preferred embodiment, substantially linear ethylene polymers are also characterized by a single DSC melting peak.

The preferred I₂ melt index for these substantially linear ethylene polymers or linear ethylene polymers is from about 0.01 g/10 min to about 100 g/10 min, more preferably about 0.1 g/10 min to about 10 g/10 min, and even more preferably about 1 g/10 min to about 5 g/10 min.

The preferred M_{w} for these substantially linear ethylene polymers or linear ethylene polymers is equal to or less than about 180,000, preferably equal to or less than about 160,000, more preferably equal to or less than about 140,000 and most preferably equal to or less than about 120,000. The preferred M_{w} for these substantially linear ethylene polymers or linear ethylene polymers is equal to or greater than about 40,000, preferably equal to or greater than about 50,000, more preferably equal to or greater than about 60,000, even more preferably equal to or greater than about 70,000, and most preferably equal to or greater than about 80,000.

In one embodiment, the S/LEP used in the process of the present invention may be graft modified. A preferred graft modification of the S/LEP is achieved with any unsaturated organic compound containing, in addition to at least one ethylenic unsaturation (e.g., at least one double bond), at least one carbonyl group (—C═O) and that will graft to a S/LEP as described above. Representative of unsaturated organic compounds that contain at least one carbonyl group are the carboxylic acids, anhydrides, esters and their salts, both metallic and nonmetallic. Preferably, the organic compound contains ethylenic unsaturation conjugated with a carbonyl group. Representative compounds include maleic, fumaric, acrylic, methacrylic, itaconic, crotonic, -methyl crotonic, and cinnamic acid and their anhydride, ester and salt derivatives, if any. Maleic anhydride is the preferred unsaturated organic compound containing at least one ethylenic unsaturation and at least one carbonyl group.

The unsaturated organic compound content of the grafted S/LEP is at least about 0.01 weight percent, preferably at least about 0.1 weight percent, more preferably at least about 0.5 weight percent, and most preferably at least about 1 weight percent based on the combined weight of the S/LEP and organic compound. The maximum amount of unsaturated organic compound content can vary to convenience, but typically it does not exceed about 10 weight percent, preferably it does not exceed about 5 weight percent, more preferably it does not exceed about 2 weight percent and most preferably it does not exceed about 1 weight percent based on the combined weight of the S/LEP and the organic compound.

In one embodiment, the first coating used in the process of the present invention is an olefin block copolymer (OBC), for example see U.S. Pat. Nos. 8,455,576; 7,579,408; 7,355,089; 7,524,911; 7,514,517; 7,582,716; and 7,504,347; all of which are incorporated in their entirety herein by reference.

“Olefin block copolymer”, “olefin block interpolymer”, “multi-block interpolymer”, “segmented interpolymer” and like terms refer to a polymer comprising two or more chemically distinct regions or segments (referred to as “blocks”) preferably joined in a linear manner, that is, a polymer comprising chemically differentiated units which are joined end-to-end with respect to polymerized olefinic, preferable ethylenic, functionality, rather than in pendent or grafted fashion. In a preferred embodiment, the blocks differ in the amount or type of incorporated comonomer, density, amount of crystallinity, crystallite size attributable to a polymer of such composition, type or degree of tacticity (isotactic or syndiotactic), regio-regularity or regio-irregularity, amount of branching (including long chain branching or hyper-branching), homogeneity or any other chemical or physical property. Compared to block interpolymers of the prior art, including interpolymers produced by sequential monomer addition, fluxional catalysts, or anionic polymerization techniques, the multi-block interpolymers used in the practice of this invention are characterized by unique distributions of both polymer polydispersity (PDI or Mw/Mn or MWD), block length distribution, and/or block number distribution, due, in a preferred embodiment, to the effect of the shuttling agent(s) in combination with multiple catalysts used in their preparation. More specifically, when produced in a continuous process, the polymers desirably possess PDI from 1.7 to 3.5, preferably from 1.8 to 3, more preferably from 1.8 to 2.5, and most preferably from 1.8 to 2.2. When produced in a batch or semi-batch process, the polymers desirably possess PDI from 1.0 to 3.5, preferably from 1.3 to 3, more preferably from 1.4 to 2.5, and most preferably from 1.4 to 2.

The term “ethylene multi-block interpolymer” means a multi-block interpolymer comprising ethylene and one or more interpolymerizable comonomers, in which ethylene comprises a plurality of the polymerized monomer units of at least one block or segment in the polymer, preferably at least 90, more preferably at least 95 and most preferably at least 98, mole percent of the block. Based on total polymer weight, the ethylene multi-block interpolymers used in the practice of the present invention preferably have an ethylene content from 25 to 97, more preferably from 40 to 96, even more preferably from 55 to 95 and most preferably from 65 to 85, percent.

Because the respective distinguishable segments or blocks formed from two of more monomers are joined into single polymer chains, the polymer cannot be completely fractionated using standard selective extraction techniques. For example, polymers containing regions that are relatively crystalline (high density segments) and regions that are relatively amorphous (lower density segments) cannot be selectively extracted or fractionated using differing solvents. In a preferred embodiment the quantity of extractable polymer using either a dialkyl ether or an alkane-solvent is less than 10, preferably less than 7, more preferably less than 5 and most preferably less than 2, percent of the total polymer weight.

In addition, the multi-block interpolymers used in the practice of the process of the present invention desirably possess a PDI fitting a Schutz-Flory distribution rather than a Poisson distribution. The use of the polymerization process described in WO 2005/090427 and U.S. Pat. No. 7,608,668 results in a product having both a polydisperse block distribution as well as a polydisperse distribution of block sizes. This results in the formation of polymer products having improved and distinguishable physical properties. The theoretical benefits of a polydisperse block distribution have been previously modeled and discussed in Potemkin, Physical Review E (1998) 57 (6), pp. 6902-6912, and Dobrynin, J. Chem. Phys. (1997) 107 (21), pp 9234-9238.

In a further embodiment, the OBC polymers used in the process of the invention, especially those made in a continuous, solution polymerization reactor, possess a most probable distribution of block lengths. In one embodiment of this invention, the ethylene multi-block interpolymers are defined as having:
(A) Mw/Mn from about 1.7 to about 3.5, at least one melting point, Tm, in degrees Celsius, and a density, d, in grams/cubic centimeter, where in the numerical values of Tm and d correspond to the relationship
Tm>−2002.9+4538.5(d)−2422.2(d)², or
(B) Mw/Mn from about 1.7 to about 3.5, and is characterized by a heat of fusion, ΔH in J/g, and a delta quantity, ΔT, in degrees Celsius defined as the temperature difference between the tallest DSC peak and the tallest CRYSTAF peak, wherein the numerical values of ΔT and ΔH have the following relationships:
ΔT>−0.1299(ΔH)+62.81 for ΔH greater than zero and up to 130 J/g
ΔT>48 C for ΔH greater than 130 J/g
wherein the CRYSTAF peak is determined using at least 5 percent of the cumulative polymer, and if less than 5 percent of the polymer has an identifiable CRYSTAF peak, then the CRYSTAF temperature is 30 C; or
(C) Elastic recovery, Re, in percent at 300 percent strain and 1 cycle measured with a compression-molded film of the ethylene/α-olefin interpolymer, and has a density, d, in grams/cubic centimeter, wherein the numerical values of Re and d satisfy the following relationship when ethylene/α-olefin interpolymer is substantially free of crosslinked phase:
Re>1481−1629(d); or
(D) Has a molecular weight fraction which elutes between 40 C and 130 C when fractionated using TREF, characterized in that the fraction has a molar comonomer content of at least 5 percent higher than that of a comparable random ethylene interpolymer fraction eluting between the same temperatures, wherein said comparable random ethylene interpolymer has the same comonomer(s) and has a melt index, density and molar comonomer content (based on the whole polymer) within 10 percent of that of the ethylene/α-olefin interpolymer, or
(E) Has a storage modulus at 25 C, G′(25 C), and a storage modulus at 100 C, G′(100 C), wherein the ratio of G′(25 C) to G′(100 C) is in the range of about 1:1 to about 9:1.
The ethylene/α-olefin interpolymer may also have:
(F) Molecular fraction which elutes between 40 C and 130 C when fractionated using TREF, characterized in that the fraction has a block index of at least 0.5 and up to about 1 and a molecular weight distribution, Mw/Mn, greater than about 1.3; or
(G) Average block index greater than zero and up to about 1.0 and a molecular weight distribution, Mw/Mn greater than about 1.3.

Suitable monomers for use in preparing the ethylene multi-block interpolymers used in the practice of this present invention include ethylene and one or more addition polymerizable monomers other than ethylene. Examples of suitable comonomers include straight-chain or branched α-olefins of 3 to 30, preferably 3 to 20, carbon atoms, such as propylene, 1-butene, 1-pentene, 3-methyl-1-butene, 1-hexene, 4-methyl-1-pentene, 3-methyl-1-pentene, 1-octene, 1-decene, 1-dodecene, 1-tetradecene, 1-hexadecene, 1-octadecene and 1-eicosene; cyclo-olefins of 3 to 30, preferably 3 to 20, carbon atoms, such as cyclopentene, cycloheptene, norbornene, 5-methyl-2-norbornene, tetracyclododecene, and 2-methyl-1,4,5,8-dimethano-1,2,3,4,4a,5,8,8a-octahydronaphthalene; di- and polyolefins, such as butadiene, isoprene, 4-methyl-1,3-pentadiene, 1,3-pentadiene, 1,4-pentadiene, 1,5-hexadiene, 1,4-hexadiene, 1,3-hexadiene, 1,3-octadiene, 1,4-octadiene, 1,5-octadiene, 1,6-octadiene, 1,7-octadiene, ethylidenenorbornene, vinyl norbornene, dicyclopentadiene, 7-methyl-1,6-octadiene, 4-ethylidene-8-methyl-1,7-nonadiene, and 5,9-dimethyl-1,4,8-decatriene; and 3-phenylpropene, 4-phenylpropene, 1,2-difluoroethylene, tetrafluoroethylene, and 3,3,3-trifluoro-1-propene.

Other ethylene multi-block interpolymers that can be used in the practice of this invention are elastomeric interpolymers of ethylene, a C₃₋₂₀ α-olefin, especially propylene, and, optionally, one or more diene monomers. Preferred α-olefins for use in this embodiment of the present invention are designated by the formula CH₂═CHR*, where R* is a linear or branched alkyl group of from 1 to 12 carbon atoms. Examples of suitable α-olefins include, but are not limited to, propylene, isobutylene, 1-butene, 1-pentene, 1-hexene, 4-methyl-1-pentene, and 1-octene. One particularly preferred α-olefin is propylene. The propylene based polymers are generally referred to in the art as EP or EPDM polymers. Suitable dienes for use in preparing such polymers, especially multi-block EPDM type-polymers include conjugated or non-conjugated, straight or branched chain-, cyclic- or polycyclic dienes containing from 4 to 20 carbon atoms. Preferred dienes include 1,4-pentadiene, 1,4-hexadiene, 5-ethylidene-2-norbornene, dicyclopentadiene, cyclohexadiene, and 5-butylidene-2-norbornene. One particularly preferred diene is 5-ethylidene-2-norbornene.

Because the diene containing polymers contain alternating segments or blocks containing greater or lesser quantities of the diene (including none) and α-olefin (including none), the total quantity of diene and α-olefin may be reduced without loss of subsequent polymer properties. That is, because the diene and α-olefin monomers are preferentially incorporated into one type of block of the polymer rather than uniformly or randomly throughout the polymer, they are more efficiently utilized and subsequently the crosslink density of the polymer can be better controlled. Such crosslinkable elastomers and the cured products have advantaged properties, including higher tensile strength and better elastic recovery.

The ethylene multi-block interpolymers useful in the practice of this invention have a density of less than 0.90, preferably less than 0.89, more preferably less than 0.885, even more preferably less than 0.88 and even more preferably less than 0.875, g/cc. The ethylene multi-block interpolymers typically have a density greater than 0.85, and more preferably greater than 0.86, g/cc. Density is measured by the procedure of ASTM D-792. Low density ethylene multi-block interpolymers are generally characterized as amorphous, flexible and having good optical properties, e.g., high transmission of visible and UV-light and low haze.

The ethylene multi-block interpolymers useful in the practice of this invention typically have a melt flow rate (MFR) of 1-10 grams per 10 minutes (g/10 min) as measured by ASTM D1238 (190° C./2.16 kg).

The ethylene multi-block interpolymers useful in the practice of this invention have a 2% secant modulus of less than about 150, preferably less than about 140, more preferably less than about 120 and even more preferably less than about 100, mPa as measured by the procedure of ASTM D-882-02. The ethylene multi-block interpolymers typically have a 2% secant modulus of greater than zero, but the lower the modulus, the better the interpolymer is adapted for use in this invention. The secant modulus is the slope of a line from the origin of a stress-strain diagram and intersecting the curve at a point of interest, and it is used to describe the stiffness of a material in the inelastic region of the diagram. Low modulus ethylene multi-block interpolymers are particularly well adapted for use in this invention because they provide stability under stress, e.g., less prone to crack upon stress or shrinkage.

The ethylene multi-block interpolymers useful in the practice of this invention typically have a melting point of less than about 125. The melting point is measured by the differential scanning calorimetry (DSC) method described in WO 2005/090427 (US2006/0199930). Ethylene multi-block interpolymers with a low melting point often exhibit desirable flexibility and thermoplasticity properties useful in the fabrication of the wire and cable sheathings of this invention.

In one embodiment of the present invention, the second layer is formed by injection molding a polyurethane elastomer composition, preferably a mixture of polyurethane based chemicals that cures to form a polyurethane elastomer. As disclosed in US Publication No. 2015/0074978, which is incorporated by reference herein in its entirety. Preferably, the polyurethane elastomer is a reaction product of a reaction mixture comprising at least one polyether polyol having a hydroxyl equivalent weight of at least 1000, 1 to 20 parts by weight of 1,4-butanediol per 100 parts by weight of the polyether polyol(s), an aromatic polyisocyanate in amount to provide an isocyanate index of 80 to 130 and metal carboxylate catalyst, preferably a zinc carboxylate catalyst.

In one embodiment, the polyurethane elastomer reaction mixture further contains an epoxy resin in an amount up to 20 parts by weight per 100 parts by weight of the polyether polyol(s), the reaction mixture is essentially devoid of a catalyst for the reaction of epoxy group with an isocyanate group to form an oxazolidinone and essentially devoid of an amine curing agent or sulfide curing agent, and the cured elastomer contains epoxy groups from the epoxy resin.

In one embodiment, the amount of metal carboxylate catalyst is 0.01 to 0.5 parts by weight per 100 parts by weight of the polyether polyol(s) that have an equivalent weight of at least 1000.

In one embodiment, the polyurethane reaction mixture contains no more than 2 parts by weight, per 100 parts by weight of the polyether polyol(s) that have an equivalent weight of at least 1000, of one or more isocyanate-reactive materials other than the polyether polyol and the 1,4-butanediol.

In one embodiment, the cured polyurethane elastomer is non-cellular.

In one embodiment, the polyurethane elastomer reaction mixture contains no more than 0.25 weight percent water, based on the entire weight of the reaction mixture.

In one embodiment, the polyurethane elastomer reaction mixture contains at least one of a water scavenger and an anti-foam agent.

In one embodiment of the process of the present invention the polyurethane reaction mixture is cured at 30° C. to 100° C.

In one embodiment of the present invention, the second layer is formed by injection molding an epoxy composition, preferably the reaction product of an ambient temperature liquid epoxy-terminated prepolymer cured with an amine or polyamine as disclosed in WO 2017/019679, which is incorporated by reference herein in its entirety.

In one embodiment, the epoxy composition is a reaction product of (a) from 50 to 95 weight percent of an ambient temperature liquid epoxy-terminated prepolymer formed by reacting a polyoxyalkyleneamine having a molecular weight of from 3,000 to 20,000 with an excess of epoxide, wherein the polyoxyalkyleneamine is represented by the formula:

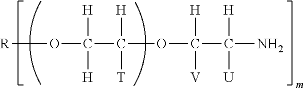

wherein R is the nucleus of an oxyalkylation-susceptible initiator containing 2-12 carbon atoms and 2 to 8 active hydrogen groups, U is an alkyl group containing 1-4 carbon atoms, preferably alkyl group containing 1 or 2 carbon groups, T and V are independently hydrogen, U, or preferably an alkyl group containing one carbon, n is number selected to provide a polyol having a molecular weight of 2,900 to 29,500, and m is an integer of 2 to 8 corresponding to the number of active hydrogen;

(b) from 5 to 30 weight percent of a short chain polyalkylene glycol diglycidyl ether of molecular weight between the range of 185 to 790;

(c) optionally a second epoxide, which can be the same or different from the first epoxide, preferably having an equivalent weight of 75 grams/equivalent to 210 grams/equivalent, in an amount of 0 to 45 weight percent;

(d) optionally a filler in an amount of 0 to 30 parts by weight wherein parts are based on 100 parts of components (a), (b), and (c), if present, preferably if present, one or more of wollastonite, barites, mica, feldspar, talc, silica, crystalline silica, fused silica, fumed silica, glass, metal powders, carbon nanotubes, graphene, calcium carbonate, or glass beads; and

(e) a curing agent comprising at least one amine or polyamine having an equivalent weight of less than 200 and having 2 to 5 active hydrogen atoms, wherein weight percent are based on the total weight of components (a), (b), and (c), if present.

In one embodiment of the present invention, the first epoxide disclosed herein above is one or more of the formula

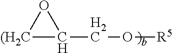

wherein R⁵ is C₆ to C₁₈ substituted or unsubstituted aromatic, a C₁ to C₈ aliphatic, or cycloaliphatic; or heterocyclic polyvalent group and b has an average value of from 1 to 8, preferably the epoxide is one or more of diglycidyl ethers of resorcinol, catechol, hydroquinone, bisphenol, bisphenol A, bisphenol AP (1,1-bis(4-hydroxylphenyl)-1-phenyl ethane), bisphenol F, bisphenol K, bisphenol S, tetrabromobisphenol A, phenol-formaldehyde novolac resins, alkyl substituted phenol-formaldehyde resins, phenol-hydroxybenzaldehyde resins, cresol-hydroxybenzaldehyde resins, dicyclopentadiene-phenol resins, dicyclopentadiene-substituted phenol resins tetramethylbiphenol, tetramethyl-tetrabromobiphenol, tetramethyltribromobiphenol, tetrachlorobisphenol A, or combinations thereof.

In another embodiment of the present invention, the epoxide disclosed herein above is at least one cycloaliphatic first epoxide of the formula

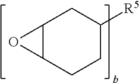

wherein R⁵ is C₆ to C₁₈ substituted or unsubstituted aromatic, a C₁ to C₈ aliphatic, or cycloaliphatic; or heterocyclic polyvalent group and b has an average value of from 1 to 8.

In another embodiment of the present invention, the first epoxide disclosed herein above is at least one divinylarene oxide of the following structures:

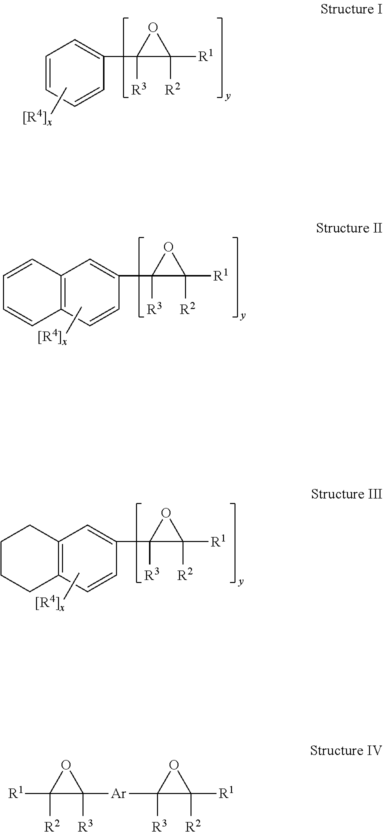

wherein each R¹, R², R³ and R⁴ is individually hydrogen, an alkyl, cycloalkyl, an aryl or an aralkyl group; or a oxidant-resistant group including for example a halogen, a nitro, an isocyanate, or an RO group, wherein R may be an alkyl, aryl or aralkyl;
x is an integer of 0 to 4;
y is an integer greater than or equal to 2 with the proviso that x+y is an integer less than or equal to 6;
z is an integer of 0 to 6 with the proviso that z+y is an integer less than or equal to 8; and
Ar is an arene fragment, preferably a 1,3-phenylene group.

In one embodiment of the present invention, the short chain polyalkylene glycol diglycidyl ether disclosed herein above is at least one or more of the formula

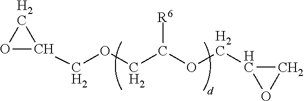

wherein R⁶ is H or C₁ to C₃ aliphatic group and d has an average value from a to 12, preferably the short chain polyalkylene glycol diglycidyl ether is poly (propylene glycol) diglycidyl ether having a molecular weight from 185 to 790.

In another embodiment of the present invention, the amine curing agent is at least one curing agent represented by the formula:

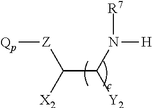

wherein R⁷, Q, X, and Y at each occurrence are independently H, C₁ to C₁₄ aliphatic, C₃ to C₁₀ cycloaliphatic, or C₆ to C₁₄ aromatic or X and Y can link to form a cyclic structure; Z is O, C, S, N, or P; c is 1 to 8; and p is 1 to 3 depending on the valence of Z.

In another embodiment of the present invention, the amine curing agent disclosed herein above is represented by the formula:

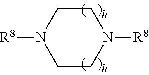

wherein R⁸ at each occurrence is independently H or —CH₂CH₂NH₂ and h is 0 to 2 with the proviso that both h's cannot be 0.

In yet another embodiment of the present invention, the epoxy composition disclosed herein above further comprises:

(f) an acrylate monomer having an acrylate equivalent weight of 85 grams/equivalent to 160 grams/equivalent, wherein the acrylate monomer component is present in an amount from 1 to 12 part per hundred parts based on the total amount epoxy resin, preferably the acrylate component is hexanediol diacrylate, tripropylene glycol diacrylate, diethylene glycol diacrylate, trimethylolpropane triacrylate, triethylene glycol diacrylate, 1,4-butanediol diacrylate, dipropylene glycol diacrylate, neopenyl glycol diacrylate, cyclohexane dimethanol diacrylate, pentaerythritol triacrylate, diptenaerythritol pentaacrylate, or combinations thereof.

In one embodiment of the present invention, the second layer is formed by injection molding a cross-linkable polyolefin composition, for example see U.S. provisional application No. 62/381,037, which is incorporated by reference herein in its entirety. Preferably, the cross-linkable polyolefin composition of the present invention comprises, consists essentially of, or consists of (i) one or more ethylene polymer, (ii) one or more silane, (iii) one or more polyfunctional organopolysiloxane with a functional end group, (iv) one or more cross-linking catalyst, and (v) optionally one or more filler and/or additive.

Preferably the one or more ethylene polymer (i) is a very low density polyethylene, a linear low density polyethylene, a homogeneously branched polyethylene, a linear ethylene/alpha-olefin copolymer, a homogeneously branched substantially linear ethylene/alpha-olefin polymer, or an ethylene block copolymer.

Preferably, the one or more silane (ii) is described by the formula:

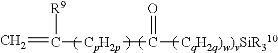

wherein R⁹ is a hydrogen atom or methyl group;

v and w are 0 or 1 with the proviso that when v is 1, w is 1;

p is an integer from 0 to 12 inclusive,

q is an integer from 1 to 12 inclusive,

and

each R¹⁰ independently is a hydrolyzable organic group.

More preferably, the silane (ii) is vinyl trimethoxy silane, acryloxypropyltrimethoxysilane, sorboloxypropyltriethoxysilane, vinyl triethoxy silane, vinyl triacetoxy silane, gamma-(meth)acryloxy propyl trimethoxy silane or mixtures thereof.

Preferably the one or more polyfunctional organopolysiloxane with a functional end group (iii) is described by the formula:

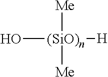

wherein Me is methyl and r is in the range of 2 to 100,000 or more, preferably in the range of 10 to 400 and more preferably in the range of 20 to 120.

More preferably, the polyfunctional organopolysiloxane (iii) is a hydroxyl-terminated polydimethylsiloxane containing at least two hydroxyl end groups, a polydimethylsiloxane having at least two amine end groups, or a moisture-crosslinkable polysiloxane.

Preferably, the one or more cross-linking catalyst (iv) is a Lewis or Bronsted acid or base.

The cross-linkable polyolefin mixture may be filled or unfilled. If filled, then the amount of filler present should preferably not exceed an amount that would cause unacceptably large degradation of the thermal and/or mechanical properties of the silane-crosslinked, ethylene polymer. Typically, the amount of filler present is between 2 and 80, preferably between 5 and 70, weight percent (wt %) based on the total weight of the composition. Representative fillers include kaolin clay, magnesium hydroxide, silica, calcium carbonate, hollow glass microspheres, and carbon blacks.

### EXAMPLES

The following components are used in Examples and Comparative Example.

“INFUSE™ 9010” is an ethylene/alpha olefin block copolymer with a melt index of 0.5 g/10 min at 190° C. and under a load of 2.16 kg and a density of 0.877 g/cm³ available from The Dow Chemical Company;

“VERSIFY™ 2000” is an ethylene/propylene substantially linear ethylene copolymer with a melt index of 2 g/10 min at 230° C. and under a load of 2.16 kg and a density of 0.888 g/cm³ available from The Dow Chemical Company;

“VERSIFY 4200” is an ethylene/propylene substantially linear ethylene copolymer with a melt index of 25 g/10 min at 230° C. and under a load of 2.16 kg and a density of 0.878 g/cm³ available from The Dow Chemical Company;

“MAH-g-VERSIFY 4200” is a maleic anhydride modified Versify 4200 made by reactive extrusion process of Versify 4200 with maleic anhydride in an extruder having a grafting content of maleic anhydride of 0.52 percent by weight;

“INTUNE™ 5545” is an ethylene/propylene block copolymer with a melt index of 9.5 g/10 min at 230° C. and under a load of 2.16 kg available from The Dow Chemical Company

“GSPP” is a glass filled syntactic polypropylene;

“VTMS” is vinyltrimethoxy silane available from The Dow Chemical Company;

“DMS-S15” which is a hydroxyl-terminated polydimethoxysiloxane available from Gelest, Inc.;

“SI-LINK DFDA-5481 NT” is a catalyst master batch comprising about 5 wt % dibutyl tin dilaurate catalyst in a linear low density polyethylene polymer available from The Dow Chemical Company; and

“X-Linked PE” is 90:10 blend of INFUSE 9010: VERSIFY 2000 grafted with vinyl trimethoxy silane (VTMS) and subsequently cross-linked in presence of a tin catalyst (SI-LINK DFDA-5481 NT) and a hydroxyl-terminated polydimethoxysilane (DMS-S15).

Example 1 is VERSIFY 4200, Example 2 is MHA-g-VERSIFY 4200, and Example 3 is INTUNE 5545. Examples 4 to 6 are 5 weight percent primer solutions of Examples 1 to 3, respectively, in methylcyclohexane (MCH).

For the comparative example, a 2 to 3 mm thick layer of GSPP is used without a primer solution. For examples of the invention, a 2 to 3 mm thick layer of GSPP is coated with a primer solution and allowed to completely dry. A 2 to 3 mm layer of X-Linked PE is placed on top of the un-coated and primer coated GSPP substrates, heated to 190° C. for 2 minutes, then pressed together in a compression press at 6,000 psi for 4 minutes, followed by 10,000 psi for 4 minutes, then followed by 15,000 psi for 2 minutes. The temperature is reduced to 25° C. and the press is held at 6,000 psi for 4 minutes, followed by 10,000 psi for 4 minutes, and then 15,000 psi for 2 minutes. Comparative Example A is the control and had the X-linked PE molded to the GSPP with no primer. Examples 7 to 9 are the molded substrates using primers Examples 4 to 6, respectively.

Peel strength is determined on one-inch strips of Comparative Example A and Examples 7 to 9 using a fixture designed for 900 peel test according to ASTM D6862. Peel strength results are shown in the Table 1.

TABLE 1

| 90° Peel Strength | Com Ex A | Example 7 | Example 8 | Example 9 |
|---|---|---|---|---|
| Avg Load/width, N/cm | 34.1 | 46.5 | 54.5 | 60.9 |

Examples of the invention demonstrate peel strength improvement of 36% to 78% over the control.

What is claimed is:

1. A method of coating a pipeline field joint between two joined lengths of pipe, each length comprising a polypropylene pipe coating along part of its length and an uncoated end portion between where the polypropylene pipe coating ends and the field joint, the method comprising the steps of
(i) applying a layer of a first coating material comprising a substantially linear ethylene polymer (SLEP), a linear ethylene polymer (LEP), or an olefin block copolymer (OBC) to the uncoated region of the field joint such that it overlaps with and extends continuously between the polypropylene pipe coating of each of the two lengths of pipe; and
(ii) subsequently applying a layer of a second coating material comprising a polyurethane, an epoxy, or a cross linked polyethylene to the field joint, wherein the second coating material contacts and completely covers the layer of the first coating material.

2. The method of claim 1 wherein the substantially linear ethylene polymer and/or linear ethylene polymer is characterized as having
(a) a density of less than about 0.873 g/cc to 0.885 g/cc and/or
(b) an I₂ of from greater than 1 g/10 min to less than 5 g/10 min.

3. The method of claim 1 wherein the OBC comprises one or more hard segment and one or more soft segment having an MFR equal to or greater than 5 g/10 min (at 190° C. under an applied load of 2.16 kg).

4. The method of claim 3 wherein the OBC is characterized by one or more of the aspects described as follows:
(i.a) has a weight average molecular weight/number average molecular weight ratio (Mw/Mn) from about 1.7 to about 3.5, at least one melting peak (Tm) in degrees Celsius, and a density (d) in grams/cubic centimeter (g/cc), wherein the numerical values of Tm and d correspond to the relationship:
Tₘ>−2002.9+4538.5(d)−2422.2(d)² or Tₘ>−6553.3+13735(d)−7051.7(d)²; or
(i.b) has a Mw/Mn from about 1.7 to about 3.5, and is characterized by a heat of fusion (ΔH) J/g and a delta quantity, ΔT, in degrees Celsius defined as the temperature difference between the tallest differential scanning calorimetry (DSC) peak and the tallest crystallization analysis fractionation (CRYSTAF) peak, wherein the numerical values of ΔT and ΔH have the following relationships:
ΔT>−0.1299(ΔH)+62.81 for ΔH greater than zero and up to 130 J/g,
ΔT≥48° C. for ΔH greater than 130 J/g,
wherein the CRYSTAF peak is determined using at least 5 percent of the cumulative polymer, and if less than 5 percent of the polymer has an identifiable CRYSTAF peak, then the CRYSTAF temperature is 30° C.; or
(i.c) is characterized by an elastic recovery (Re) in percent at 300 percent strain and 1 cycle measured with a compression-molded film of the ethylene/alpha-olefin interpolymer, and has a density (d) in grams/cubic centimeter (g/cc), wherein the numerical values of Re and d satisfy the following relationship when ethylene/alpha-olefin interpolymer is substantially free of a cross-linked phase: Re>1481-1629(d); or
(i.d) has a molecular fraction which elutes between 40° C. and 130° C. when fractionated using TREF, characterized in that the fraction has a molar comonomer content greater than, or equal to, the quantity (−0.2013) T+20.07, more preferably greater than or equal to the quantity (−0.2013) T+21.07, where T is the numerical value of the peak elution temperature of the TREF fraction, measured in ° C.; or
(i.e) has a storage modulus at 25° C. (G′(25° C.)) and a storage modulus at 100° C. (G′(100° C.)) wherein the ratio of G′(25° C.) to G′(100° C.) is in the range of about 1:1 to about 9:1 or
(i.f) has a molecular fraction which elutes between 40° C. and 130° C. when fractionated using TREF, characterized in that the fraction has a block index of at least 0.5 and up to about 1 and a molecular weight distribution, Mw/Mn, greater than about 1.3; or
(i.g) has an average block index greater than zero and up to about 1.0 and a molecular weight distribution, Mw/Mn, greater than about 1.3.

5. The method of claim 1 wherein the second coating material is formed from a composition comprising
(a) a mixture of polyurethane based chemicals that cures to form a polyurethane elastomer,
(b) an epoxy composition,
or
(c) a cross-linkable polyolefin mixture.

6. The method of claim 1 wherein the second coating material is a polyurethane elastomer which is a reaction product of a reaction mixture comprising at least one polyether polyol having a hydroxyl equivalent weight of at least 1000, 1 to 20 parts by weight of 1,4-butanediol per 100 parts by weight of the polyether polyol(s), an aromatic polyisocyanate in amount to provide an isocyanate index of 80 to 130 and a zinc carboxylate catalyst.

7. The method of claim 1 wherein the second coating material is an epoxy composition which is a reaction product of
(a) an ambient temperature liquid epoxy-terminated prepolymer formed by reacting a polyoxyalkyleneamine having a molecular weight of from 3,000 to 20,000 with an excess of epoxide, wherein the polyoxyalkyleneamine has at least 3 active hydrogen atoms
and
(b) a curing agent comprising at least one amine or polyamine having an equivalent weight of less than 200 and having 2 to 5 active hydrogen atoms.

8. The method of claim 1 wherein the second coating material comprises a cross-linkable mixture comprising:
(i) one or more ethylene polymer,
(ii) one or more silane,
(iii) one or more polyfunctional organopolysiloxane with a functional end group,
(iv) one or more cross-linking catalyst,
and
(v) optionally one or more filler and/or additive.

9. The process of claim 8 wherein
(i) the ethylene polymer is a very low density polyethylene, a linear low density polyethylene, a homogeneously branched polyethylene, a linear ethylene/alpha-olefin copolymer, a homogeneously branched substantially linear ethylene/alpha-olefin polymer, or an ethylene block copolymer,
(ii) the silane has the formula: 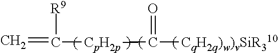
wherein R⁹ is a hydrogen atom or methyl group;
v and w are 0 or 1 with the proviso that when v is 1, w is 1;
p is an integer from 0 to 12 inclusive,
q is an integer from 1 to 12 inclusive, and
each R¹⁰ independently is a hydrolyzable organic group,
(iii) the polyfunctional organopolysiloxane (iii) is a polydimethylsiloxane of the formula: 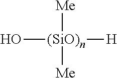
wherein Me is methyl and n is from 10 to 400,
and
(iv) the cross-linking catalyst is a Lewis or Bronsted acid or base.
